(19) United States
(12) Patent Application Publication
(10) Pub. No.: US 2006/0074709 A1
(43) Pub. Date: Apr. 6, 2006

(54) Method for providing a remote diagnostic

(76) Inventor: John McAllister, Notre Dame de I'Ile Perrot (CA)

Correspondence Address: OGILVY RENAULT LLP, 1981 MCGILL COLLEGE AVENUE, SUITE 1600, MONTREAL, QC, H3A2Y3, CA

(21) Appl. No.: 10/951,713

(22) Filed: Sep. 29, 2004

(51) Int. Cl. G06Q 50/00

(52) U.S. Cl. 705/2

(57) ABSTRACT

A method for providing medical diagnostic equipment in a patient's home to permit remote assessment by a medical practitioner is described. A need for a particular diagnostic equipment to be set up in the patient's home is identified. a request is placed for diagnostic equipment to be allocated to the patient. The diagnostic equipment is dispensed to the patient together with instructions as to how to set up the equipment. The diagnostic equipment is set up in the patient's home according to the instruction and is used for recording physiological data allowing a remote assessment of the patient. The diagnostic equipment is returned after use and the physiological data is validated by a technician. The physiological data is then analyzed and an assessment of the patient is provided.

### FIELD OF THE INVENTION

The invention relates to a method for acquisition of physiological data for diagnostic purposes. More specifically, it relates to a method for providing medical diagnostic equipment in a patient's home to permit remote assessment of sleep disorders by a medical practitioner.

### BACKGROUND OF THE INVENTION

Obstructive Sleep Apnea (OSA) is a common disorder in the practice of sleep medicine and is responsible for more mortality and morbidity than any other sleep disorder. The condition is marked by recurrent failures to breathe during sleep (called apneas or hypopneas), which over time, can lead to many health complications. Obstructive Sleep Apnea is the most common type of breathing interruption due to an obstruction in the upper airway. The obstruction may be caused by an over-relaxation of the throat muscles and tongue which partially or fully block the airway. During an apnea or hypopnea, which are commonly known as respiratory events, oxygen levels in the brain can decrease, while carbon dioxide levels rise, giving the patient a feeling of suffocation, which could prompt him to wake up. Other physiological changes occurring due to apnea are increased heart rate and blood pressure levels.

Pediatric adenotonsillectomy is a procedure oftentimes performed on patients suffering from OSA. For some patients requiring urgent adenotonsillectomy, a high incidence of postoperative respiratory complications has been observed. Researchers and studies have shown that exists a direct link between OSA severity and the risk for postoperative respiratory complications. Practitioners therefore recommend that the preoperative evaluation of patients with OSA includes an assessment of risk factors.

Currently, for accurate OSA diagnosis and risk evaluation, the patient must be admitted for an overnight sleep study, known as polysomnography, at a specialized sleep laboratory. During the sleep study, the patient sleeps in the laboratory and is connected to equipment which measures and records physical reactions and brainwave activity during sleep. The data recorded is later used by technicians and specialists in providing a diagnostic.

Unfortunately, there are many disadvantages associated with a polysomnography test. The limited availability of facilities and trained technicians has resulted in delays in scheduling laboratory time and a growing number of patients awaiting for a test. For patients who require surgery immediately, such a situation is especially problematic, as the operation is performed without the adequate risk evaluation.

Additionally, the high cost of a polysomnography study presents a problem for patients who are not covered by a private health insurance policy. For economic reasons, these patients may have to undergo surgery without the results of such a study, or remain untreated.

Overnight oximetry tests are a recommended alternative to polysomnography studies, as they enable decisions in the treatment of patients requiring adenotonsillectomy. Scoring systems for overnight oximetry have been validated and proven to reflect OSA severity and indicate patients who are at increased risk of postoperative respiratory compromise. Prioritizing operative intervention on the basis of oximetry test results can shorten the diagnostic and treatment process, which for some patients is a crucial aspect.

Devices and systems have been developed that allow performing overnight oximetry tests for assessing OSA at home. However, these devices and systems suffer from significant drawbacks.

In existing OSA assessment tests, the patient, the practitioner, the specialists and the technician interact independently, as there is no centralized system allowing them to schedule their activities and exchange information in an efficient manner. Patient background information cannot be input and compiled automatically and patient clinical data cannot be interpreted automatically by existing systems. At each step of the diagnostic, the medical practitioner or the specialist has to intervene, which decreases efficiency and increases costs. There exists therefore a need for a method that allows data processing and sharing such as to reduce the time to produce a diagnosis and to reduce the time that a medical practitioner must spend in each patient file.

### SUMMARY OF THE INVENTION

Accordingly, an object of the present invention is to provide a method of assessing OSA which is efficient, highly available and inexpensive.

According to a first broad aspect of the present invention, there is provided a method for providing medical diagnostic equipment in a patient's home to permit remote assessment by a medical practitioner. The method comprises identifying a need for a particular diagnostic equipment to be set up in the home; requesting that the diagnostic equipment be allocated to the patient; dispensing the diagnostic equipment according to the request to the patient and providing instructions on how to set up the equipment; setting up the diagnostic equipment in the patient's home in accordance with the instructions; using the diagnostic equipment for recording data allowing the remote assessment of the patient; returning the medical diagnostic equipment after use as prescribed by the medical practitioner; and validating the recorded data by a technician at a remote location, before the remote assessment is performed by the medical practitioner.

According to another broad aspect of the present invention, there is provided a method for providing medical diagnostic equipment in a patient's home to permit remote assessment by a medical practitioner, the method comprising: identifying a need for a particular diagnostic equipment to be set up in the home; providing diagnostic equipment and instructions on how to set up the equipment; setting up the diagnostic equipment in the patient's home in accordance with the instructions; setting up a camera in the patient's home for recording video information; using the camera to record the video information on a video recording medium; using the diagnostic equipment for recording physiological data of the patient; encoding said recorded physiological data onto an audio channel of said video recording medium such that the physiological data is synchronized with the video information; returning the diagnostic equipment after use as prescribed by the medical practitioner; and using the recorded physiological data from the audio channel together with the recorded video information to index events, so that the medical practitioner may view them without scanning through all the recorded information.

According to yet another broad aspect of the present invention, there is provided a method for providing medical diagnostic equipment in a patient's home to permit remote assessment by a medical practitioner, the method comprising: identifying a need for a particular diagnostic equipment to be set up in the home; using the diagnostic equipment for recording video information and diagnostic data allowing the remote assessment of the patient; providing the recorded video information to a codec for digital encoding; reading a codec signal indicating a degree of motion in the recorded video information; and using the codec signal together with the diagnostic data thresholds to index events to be used by the medical practitioner for the remote assessment.

According to another broad aspect of the present invention, there is provided a method for providing medical diagnostic equipment to a patient to permit assessment by a medical practitioner. The method comprises identifying a need for a particular diagnostic equipment to be set up; establishing a data link between the diagnostic equipment and the patient; using the diagnostic equipment for recording diagnostic data allowing the assessment of the patient; and using the link to automatically match the diagnostic data with a corresponding patient file, for performing the assessment.

According to another broad aspect of the present invention, there is provided a method for providing medical diagnostic equipment to a patient to permit remote assessment by a medical practitioner. The method comprises identifying a need for a particular diagnostic equipment to be set up; requesting that the diagnostic equipment be allocated to the patient; establishing a link between the diagnostic equipment and an analysis protocol; using the diagnostic equipment for recording diagnostic data allowing the remote assessment of the patient; and using the link to select an analysis protocol for analyzing the diagnostic data for the patient before providing the remote assessment.

### BRIEF DESCRIPTION OF THE DRAWINGS

These and other features, aspects and advantages of the present invention will become better understood with regard to the following description and accompanying drawings wherein:

FIG. 1 is a block diagram of a diagnostic system according to the preferred embodiment of the present invention;

FIG. 2 is a flow chart of a method for providing medical diagnostic equipment in a patient's home to permit remote assessment by a medical practitioner according to the preferred embodiment of the present invention;

### DETAILED DESCRIPTION OF THE PREFERRED EMBODIMENT

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

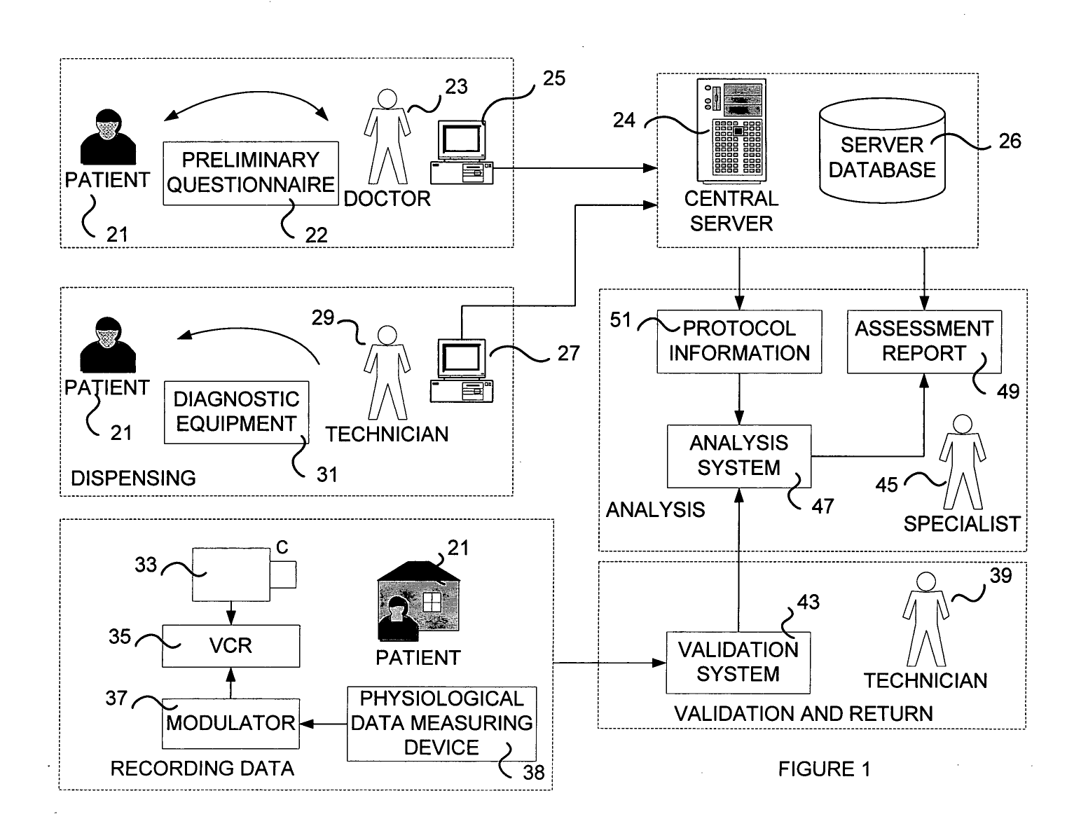

According to one broad aspect of the present invention and as illustrated in FIG. 1, a system for OSA diagnosis will be described. The system allows for collecting patient medical background information, diagnostic data information, analyzing the data and making assessments of a particular patient condition.

While the following description of the preferred embodiment refers to a method for providing an OSA diagnosis, it will be understood by those skilled in the art that the method of the present invention could be applied for providing diagnosis of other conditions as well.

The system connects multiple stations through a plurality of communication networks, such as, for example, the Internet and/or wireless networks. The stations are terminal stations 25, 27 and one or multiple servers 24, which communicate over data networks, through preferably a TCP/IP communication protocol. A terminal station 25 27 is preferably a personal computer, but could also be some other type of communication device, such as an Internet-enabled Personal Digital Assistant (PDA).

A main server 24 includes storage means 26 for storing patient information for a plurality of patients. The contents of the server storage means 26 may be accessed through a web-enabled browser, such as, for example a Microsoft Internet Explorer browser. Users of the system include medical practitioners 23, specialists 45, technicians 29 39, patients 21, etc. The server 24 manages user information and access to the storage means 26, such that only registered users may access its contents. A registered user will have to provide credential information, such as a username and a password, using a 128-bit encryption, in order to be identified by the server 24. If the provided user information is valid, the corresponding user home page is accessed, according to the specified user profile and privilege levels. If the information is found to be invalid, an error message may be generated or the system may prompt the user to re-enter new credential information.

For security purposes, all login activities are recorded, data transmissions are encrypted and users are automatically logged off after an extended period of inactivity.

The initial page for all users upon accessing the application is their home page. The home page is used to both summarize information relating to the user and to manage access to other areas of the application. The content of the home page depends upon the user profile. For example, a technician view may show test appointments scheduled for the upcoming two weeks with links to the appointment details. A medical practitioner's home page might show text reports awaiting validation with links to the corresponding patient information. A subscribing user may access various application functionalities by means of an application menu. The functional menu is the application management tool, both managing the flow of a test and allowing access to details of an existing test.

Preferably, a graphical user interface provides to the user access to the system functions. The graphical user interface includes selection means, such as checkboxes, drop-down menus, links, data entry fields, etc. The interface allows for easy user account management, patient information management, diagnosis validation and appointment scheduling.

FIG. 1 shows a block diagram of the interaction between different users and various stations and devices that are part of the system of the preferred embodiment. A patient 21, who shows symptoms of having sleep apnea or a similar sleep-related disorder, is initially seen by a general medical practitioner 23 who does not necessarily specialize in sleep disorders. Upon setting up an appointment with a medical practitioner 23, a patient file is created and is associated with the referring medical practitioner 23. The patient file is stored by the server 24 in the server database 26, from where it can be retrieved by all authorized users. The patient file contains a unique patient identification information, which can be used to retrieve the corresponding patient file. The patient file also contains information such as the patient's contact information, referring medical practitioner 23 information, as well as administrative information. All changes to patient details are audited by the system.

The medical practitioner 23 may retrieve a patient file by accessing the system through a terminal 25. The patient information is summarized in a patient summary view. For each different test associated with that particular patient, information is summarized in a study header. A study action field indicates to the medical practitioner 23, or to any other authorized user, what the next step in the assessment process should be.

In a first step, the patient 21 is provided with a preliminary questionnaire 22 by the medical practitioner 23. The preliminary questionnaire 22, to be filled out by the patient 21, will provide patient background information and will allow the medical practitioner and system to assess the suitability of the patient for a sleep apnea home study. The questionnaire 22 can be completed remotely by the patient and submitted through the website, via e-mail, fax or in person. The questionnaire 22 results are scored to assist in the creation of a diagnosis. In the case of an electronic submission, all input information is checked for validity and the user is not allowed to proceed until the information provided is correct. At the same time, warnings are automatically created if the patient history could have an impact on the test or the test results. The questionnaire 22 consists of generic physiological questions, medical history questions and sleep/snoring specific questions. The contents of such a preliminary questionnaire 22 should be obvious to those skilled in the art, as it is based on surveys frequently used at hospital sleep clinics.

The preliminary questionnaire 22 results for a given patient are stored in that patient's file in the system database. The system application determines the patient's suitability for in-home testing based on criteria validated in case histories. For example, the preliminary questionnaire 22 results may be analyzed with respect to statistical data based on surveys carried out among groups of similar sleep apnea patients.

If the patient 21 is deemed suitable for a home study, the medical practitioner 23 may then place a request that a diagnostic equipment 31 be dispensed to the patient 21. A technician 29 receives the request for equipment through a terminal station 27. The request may be received from any user authorized by the system to place orders for physiological data measuring diagnostic equipment 31. The request may be placed through telephone, fax, e-mail or using an Internet browser. The request for diagnostic equipment 31 is associated with a corresponding patient file. The medical practitioner 23 specifies in the request which type of diagnostic equipment 31 is to be given out to the patient, since it is likely that more than one type of diagnostic equipment 31 is available for a given condition.

A user can also schedule a time for receiving and returning the diagnostic equipment 31. In the preferred embodiment of the present invention, the “test schedule” function provided by the on-line application is used to assign a time for a patient to pick up and/or receive the diagnostic equipment 31. At the time of scheduling, the test completion date and time are specified, together with the study type.

In the preferred embodiment of the present invention, the system creates warnings in the case in which multiple tests are scheduled simultaneously. Tests must be confirmed as soon as they are completed, so that results can be tabulated into a report. Warnings are created if test appointments occurring in the past have not been confirmed.

When logged on to the application, the “view schedule” option allows a user, such as a technician, to view a calendar showing all scheduled tests for a given month and their status. A test can be scheduled, pending or confirmed. Each test appointment contains the name of the patient and the appointment time, as well as a link to the patient study summary.

The technician 29 selects the recommended diagnostic equipment 31 from an inventory of equipment and gives it to the patient 21. The technician 29 provides at the same time instructions as to how the patient should use the diagnostic equipment and how to set up the diagnostic equipment 31 correctly. It is to be understood that the same diagnostic equipment 31 could be used for recording physiological data for a variety of conditions, therefore the technician 29 must specify to the patient 21 how to use the equipment in the appropriate way.

In the preferred embodiment of the present invention, the diagnostic equipment 31 includes a camera 33, video recording means 35, a modulator 37 and physiological data measuring device 38. The physiological data measuring device 38 is a portable pulse oximeter device. At the time that the diagnostic equipment 31 is dispensed to the patient 21, a patient identification number is provided to the oximeter device 38. The link created between the oximeter device 38 and the patient 21, by means of the patient identification number, will allow to associate the data recorded by the diagnostic equipment 31 with the appropriate patient 21. Alternatively, the oximeter device 38 serial number might be entered into the system and associated with the patient file.

In alternative embodiments, additional physiological data measuring devices can be used such as a respiratory inductive plethysmograph (RIP), an ECG electrocardiogram, an accelerometer posture indicator and/or an accelerometer motion indicator.

At home, the patient 21 sets up the equipment for recording diagnostic data according to the instructions as shown in FIG. 1. The description of the preferred embodiment will be made in reference to the case in which the diagnostic equipment 31 comprises a portable pulse oximeter device 38 for measuring physiological data. The description will refer to the use of a portable pulse oximeter device 38 to create a diagnosis for OSA. A similar equipment setup could also be applied for collecting and recording data in the diagnostic of other conditions such as, bronchopulmonary dysplasia, central sleep apnea and chronic lung disease.

In the preferred embodiment of the present invention, the diagnostic equipment 31 comprises a video recording means, such as a camera 33, connected to a video cassette recorder (VCR) 35. Alternatively, a camcorder could be provided for the same purpose. The camera is preferably an infrared camera for recording in low-level lighting conditions. At the same time, the oximeter device 38 is set up in connection with a modulator 37. The oximeter device 38 is used for measuring physiological data such as the level of blood oxygenation (SPO2), the blood flow (perfusion) and the pulse rate. The camera 33 is used to record video information at the same time as the physiological data is being recorded.

In an alternative embodiment of the present invention, the video information and the physiological data might be recorded as digital information into a single stream, using a protocol such as the MPEG encoding scheme. The audio track of the MPEG stream could be used to record physiological data synchronized with the video information. The MPEG stream generated could be transmitted over a low bandwidth network to a remote user for real-time processing or recorded on a local computer storage.

The measured analog physiological data is converted to a digital format by the oximeter device 38 and a digital output is provided to the modulator 37. The digital physiological data signals are modulated so that they are within the audio range and can be recorded on an audio track of the video recording medium of the VCR 35. The modulator 37 is in communication with the VCR 35 for providing a signal thereto. The physiological data and the video information are recorded synchronously such as to facilitate data analysis. By having the video information and the physiological data synchronized, the two channels can be cross-correlated to provide an indexed version of the recording, such that extracts may be viewed selectively from the entire recording. In alternative embodiments of the present invention, audio information could be recorded as well on another audio track of the video recording means.

In an alternative embodiment, the diagnostic equipment 31 does not include video recording means, such that the diagnostic physiological data is recorded on the oximeter device 38 and not on a video recording medium.

Once the diagnostic equipment 31 has been used for recording, the patient 21 returns the diagnostic equipment 31 to the equipment center. The recorded physiological data must first be downloaded from the diagnostic equipment 31 and matched with the corresponding patient file. For that purpose, the patient identification information is first downloaded from the oximeter device 38. The patient identification information could be a reference number that uniquely identifies a patient and a patient file in the system database. The patient identification information is used to access the system database, to retrieve the appropriate patient file and to upload the physiological data into that file.

In an alternative embodiment, in the case in which an off-the-shelf oximeter device 38 was used, a serial number associated with the oximeter device 38 could be read from the device. The oximeter device 38 serial number had previously been associated to a set of instructions as to how the physiological data will be analyzed, or to a specific patient case.

A technician 39 proceeds to validate the physiological data recorded by the diagnostic equipment 31. The validation system 43 ensures for example that the data provided is indeed originating from the right patient and that the data is not erroneous. The technician 39 first uploads the raw waveforms of the diagnostic data from the diagnostic equipment 31 into a system 47 that will perform the analysis. In the preferred embodiment of the present invention, the raw waveforms of physiological data are recorded onto a video recording means, such as a video tape.

Before video information and recorded physiological data can be analyzed by a computer analysis system, the analog information has to be converted into a computer-readable format. Preferably, a lossless high efficiency compression format is used for compression and conversion. A compression scheme well known in the art and suitable for this type of application is for example, the MPEG encoding scheme.

A common digital conversion and compression device is a codec. A codec performs analysis at the same time as it compresses video information, such that it can provide various parameter values for each video frame.

An important parameter value that is used in the present invention is a degree of motion parameter value. In the case of sleep apnea, it is important to study the movements of a patient as recorded while the patient was sleeping and physiological data was being collected. The movements of the patient together with the recorded physiological data can provide an accurate indication of whether an apnea event has occurred. The movement of a patient can be analyzed by comparing the patient object in consecutive frames and calculating a degree of motion. The motion parameter value, taken together with the recorded physiological data at the same time stamp, completely and accurately describe the patient state.

Preferably, recorded physiological data is decoded from the audio track and graphically represented on a display terminal, such that it can be read by the technician and reviewed for errors. Erroneous physiological data could have been recorded as a result of the diagnostic equipment not having been set up properly by the patient 21.

The validated data is then sent to an analysis system 47, where the data is analyzed according to an analysis protocol. The analysis protocol 51 is chosen from a variety of protocols corresponding to a variety of tests, and is in accordance with the medical practitioner's 23 recommendations. The analysis protocol is retrieved according to information in the patient file, in which the medical practitioner has set out specific instructions as to what information is required from the analysis of the physiological data. Alternatively, protocol information might be retrieved by using the oximeter device 38 serial number which is associated with a specific analysis protocol.

In one embodiment of the present invention, the analysis is performed by a specialist 45. However, in other embodiments, the analysis might be performed by the same technician 39 who validates the recorded physiological data.

In yet another embodiment, the physiological data could also automatically be analyzed by a system software. Such a system software allows for desaturation periods present in the data to be automatically identified, counted and categorized.

During the analysis, the physiological data is compared against threshold values for detecting whether clinically significant events have occurred. The data at a given time stamp is analyzed together with the motion parameter value at the same time stamp. Events are temporally indexed and tagged, such that they may be retrieved easily during the diagnosis process.

The results produced with the analysis system 47 include sleep information, apnea/hypopnea table, cardio-respiratory parameters and additional specialist 45 comments.

The results can be inputted manually into the patient file by the technician performing the assessment or can be imported directly from the system software. The results are used to produce automatically an on-line report, which is a summary of the diagnosis and the diagnostic data used for that purpose. The report includes a summary of important patient information, including: preliminary questionnaire results, testing results, level of OSA determined, interpretation of testing results and conclusions, as well as additional recommendations and warnings. The information contained in the report can be sent by means of mail, fax or e-mail to the medical practitioner, or it can be consulted on-line. The contents of the report are produced automatically and will have to be approved by a specialist.

During an on-line consult session, the specialist approves or modifies the report contents. The final report includes an introduction, a diagnosis and recommendation, patient background information, results summary, as well as any additional specialist comments.

The report could contain the relevant indexed events to be submitted to the medical practitioner. In the case in which the medical practitioner 23 would like the opinion of another specialist, the report together with the indexed data events could be sent for another assessment.

In one embodiment of the present invention, the final report is printed onto the original consult received from the medical practitioner, who can either access it on-line or receive it by means of mail, fax or e-mail.

In order to close the case, a patient study must be validated by the specialist. Upon validation, the preliminary questionnaire, OAS results and final report are saved and archived such that no further modifications can be made thereto.

Following completion of a study, a follow-up questionnaire is provided to the patient 21 requesting feedback regarding the evaluation and the changes observed as a result of the treatment. The follow-up questionnaire can be completed on-line or submitted by mail, fax or e-mail.

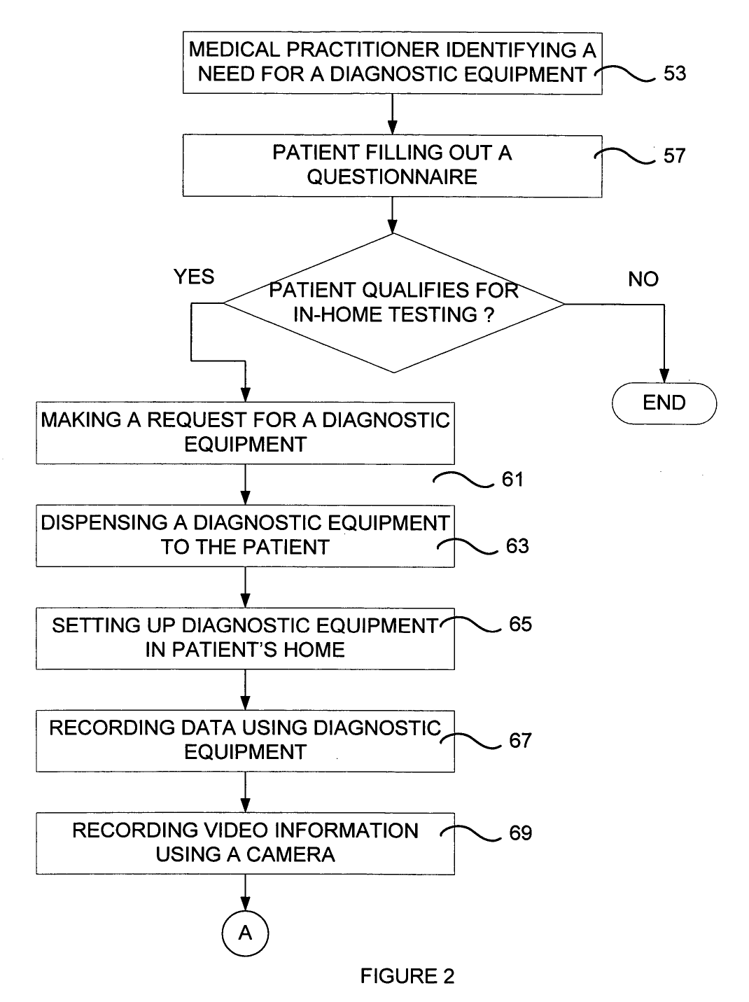

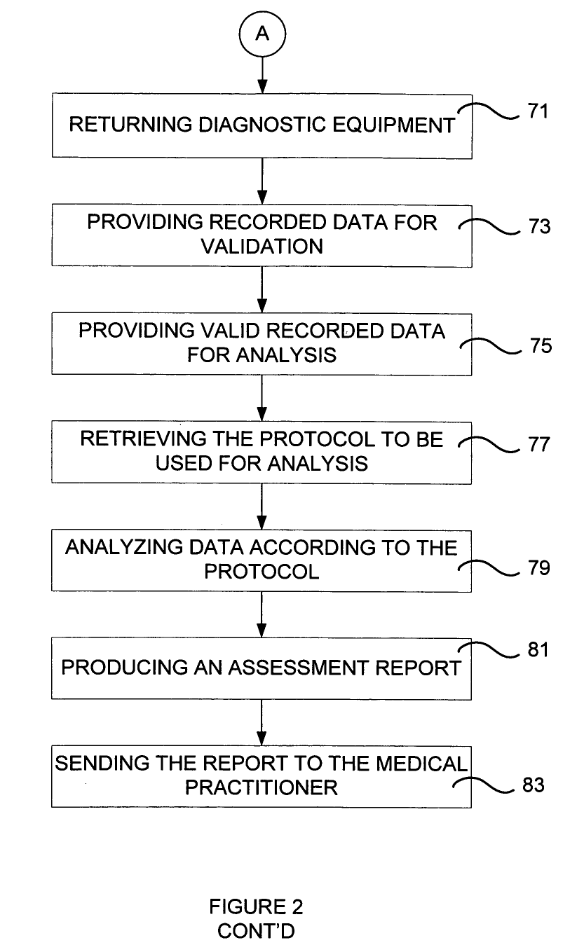

FIG. 2 illustrates a method for providing medical diagnostic equipment in a patient's home to permit remote assessment by a medical practitioner as implemented by the system described above.

In a first step, a medical practitioner identifies a need for a diagnostic equipment 53. The patient then fills out a preliminary questionnaire 57, in order to determine suitability for in-home testing.

If the results of the preliminary questionnaire are such that the patient does not qualify for in-home testing, other methods of testing will be suggested to the patient by the medical practitioner 23.

If the preliminary questionnaire indicates that the patient is suitable for in-home testing, then, as per step 61, the medical practitioner 23 places a request for diagnostic equipment 31. In accordance with the medical practitioner's request, the diagnostic equipment 31 is dispensed 63 to the patient 21.

In the preferred embodiment of the present invention, the patient 21 is provided with instructions as to how to use the diagnostic equipment 31, according to the medical practitioner's 23 recommendations.

In alternative embodiments of the present invention, the steps of placing a request 61 for diagnostic equipment 31 and dispensing 63 the diagnostic equipment to the patient 21 in accordance with the request are optional. The diagnostic equipment 31 and the instructions for use could be provided to the patient 21 following a positive assessment of suitability at the medical practitioner's 23 office.

The diagnostic equipment 31 is then set up 65 in the patient's home. In the preferred embodiment of the present invention, it is the patient 21 who sets up the diagnostic equipment 31, according to the instructions that were provided with the equipment. In alternative embodiments, a technician could travel to the patient's home to set up the diagnostic equipment 31, insuring proper installation and use. Alternatively, the diagnostic equipment could be used in other locations than a patient's home, such as clinics, hospitals, providing the same purpose of collecting physiological data in order to provide a remote assessment for a patient.

The diagnostic equipment 31 is used for recording 67 physiological data associated with a condition. In the preferred embodiment of the present invention, the condition studied is a sleep disorder, such as sleep apnea and the diagnostic equipment comprises a pulse oximeter device 38.

In the preferred embodiment of the present invention, a camera, which is part of the diagnostic equipment 31, is used for recording 69 video information. In alternative embodiments of the present invention, a camera and video recording means are optional, the diagnostic equipment 31 comprising only a physiological data measuring and recording device. In the alternative embodiment, physiological data would not be recorded on an audio track, but in a memory part of the measuring and recording device.

In yet another embodiment of the present invention, the measured physiological data could be transmitted over a network to a receiving unit, such as a docking station, at an analysis center.

In a next step, the diagnostic equipment is returned 71 to the diagnostic equipment center. The recorded physiological data is provided 73 for validation.

After being validated, the valid physiological data 75 is provided 75 to an analysis system for analysis.

The protocol to be used for the analysis is retrieved 77 from the server.

The physiological data is analyzed 79 according to the protocol and an assessment report is produced 81.

The assessment report is sent to the referring medical practitioner 23.

It will be understood that numerous modifications thereto will appear to those skilled in the art. Accordingly, the above description and accompanying drawings should be taken as illustrative of the invention and not in a limiting sense. It will further be understood that it is intended to cover any variations, uses, or adaptations of the invention following, in general, the principles of the invention and including such departures from the present disclosure as come within known or customary practice within the art to which the invention pertains and as may be applied to the essential features herein before set forth, and as follows in the scope of the appended claims.

What is claimed is:

1. A method for providing medical diagnostic equipment in a patient's home to permit remote assessment by a medical practitioner, said method comprising:
identifying a need for a particular diagnostic equipment to be set up in said home;
requesting that said diagnostic equipment be allocated to said patient;
dispensing said diagnostic equipment according to said request to said patient and providing instructions on how to set up said equipment;
setting up said diagnostic equipment in said patient's home in accordance with said instructions;
using said diagnostic equipment for recording diagnosis data allowing said remote assessment of said patient;
returning said medical diagnostic equipment after use as prescribed by said medical practitioner; and
validating said recorded data by a technician at a remote location, before said remote assessment is performed by said medical practitioner.

2. A method as claimed in claim 1, wherein said validating said recorded diagnosis data comprises an authentication of said patient by analysis of said recorded diagnosis data.

3. A method as claimed in claim 1, wherein said validating said recorded data comprises verifying that said diagnostic equipment was set up by said patient according to said instructions.

4. A method as claimed in claim 1, wherein said requesting allocation of said equipment comprises said medical practitioner placing an electronic request for said diagnostic equipment to be dispensed to said patient.

5. A method as claimed in claim 1, wherein said remote assessment is an assessment of a sleep disorder.

6. A method as claimed in claimed 1, wherein said diagnostic equipment comprises a pulse oximeter device.

7. A method as claimed in claim 1, wherein said recorded data is patient physiological data.

8. A method as claimed in claim 7, wherein said recorded physiological data is blood oxygen level information and pulse rate information.

9. A method as claimed in claim 1, wherein said medical practitioner performing said identifying a need and said requesting diagnostic equipment is a generalist medical practitioner and wherein said medical practitioner performing a remote assessment is a specialist medical practitioner.

10. A method for providing medical diagnostic equipment in a patient's home to permit remote assessment by a medical practitioner, said method comprising:
identifying a need for a particular diagnostic equipment to be set up in said home;
providing diagnostic equipment and instructions on how to set up said equipment;
setting up said diagnostic equipment in said patient's home in accordance with said instructions;
setting up a camera in said patient's home for recording video information;
using said camera to record said video information on a video recording medium;
using said diagnostic equipment for recording physiological data of said patient;
encoding said recorded physiological data onto an audio channel of said video recording medium such that said physiological data is synchronized with said video information;
returning said diagnostic equipment after use as prescribed by said medical practitioner; and
using said recorded physiological data from said audio channel together with said recorded video information to index events, so that said medical practitioner may view them without scanning through all said recorded information.

11. A method as claimed in claim 10, wherein said medical practitioner performing said identifying a need and said requesting diagnostic equipment is a generalist medical practitioner and wherein said medical practitioner performing a remote assessment is a specialist medical practitioner.

12. A method as claimed in claim 10, further comprising:
recording audio information on another channel of said video recording medium.

13. A method as claimed in claim 10, wherein said camera is an infrared camera for recording in low lighting conditions.

14. A method as claimed in claim 10, wherein said step of providing diagnostic equipment comprises:
requesting that said diagnostic equipment be allocated to said patient; and
dispensing said diagnostic equipment according to said request to said patient and providing instructions on how to set up said equipment.

15. A method as claimed in claim 14, wherein said requesting allocation of said equipment comprises said medical practitioner placing an electronic request for said diagnostic equipment to be dispensed to said patient.

16. A method as claimed in claim 10, wherein said remote assessment is an assessment of a sleep disorder.

17. A method as claimed in claim 16, wherein said diagnostic equipment comprises a pulse oximeter device.

18. A method as claimed in claim 10, wherein said recorded physiological data is blood oxygen level information and pulse rate information.

19. A method for providing medical diagnostic equipment in a patient's home to permit remote assessment by a medical practitioner, said method comprising:
identifying a need for a particular diagnostic equipment to be set up in said home;
using said diagnostic equipment for recording video information and physiological data allowing said remote assessment of said patient;
providing said recorded video information to a codec for digital encoding;
reading a codec signal indicating a degree of motion in said recorded video information; and
using said codec signal together with said physiological data thresholds to index events to be used by said medical practitioner for said remote assessment.

20. A method as claimed in claim 19, further comprising:
requesting that said diagnostic equipment be allocated to said patient;
dispensing said diagnostic equipment to said patient and providing instructions on how to set up said equipment;
setting up said diagnostic equipment in said patient's home in accordance with said instructions; and
returning said medical diagnostic equipment after use as prescribed by said medical practitioner.

21. A method as claimed in claim 19, wherein said diagnostic equipment comprises a pulse oximeter device.

22. A method as claimed in claim 19, wherein said recorded physiological data is blood oxygen level information and pulse rate information.

23. A method for providing medical diagnostic equipment to a patient to permit assessment by a medical practitioner, said method comprising:
identifying a need for a particular diagnostic equipment to be set up;
establishing a data link between said diagnostic equipment and said patient;
using said diagnostic equipment for recording diagnostic data allowing said assessment of said patient; and
using said link to automatically match said diagnostic data with a corresponding patient file, for performing said assessment.

24. A method as claimed in claim 23, wherein said establishing a link comprises:
uploading a patient identification information into said diagnostic equipment;
and wherein using said link comprises:
downloading said patient identification information from said diagnostic equipment and using it to retrieve said patient file.

25. A method as claimed in claim 23, wherein said diagnostic equipment is set up at a patient's home.

26. A method as claimed in claim 23, wherein said recorded diagnosis data is patient physiological data.

27. A method as claimed in claim 26, wherein said recorded physiological data is blood oxygen level information and pulse rate information.

28. A method as claimed in claim 23, further comprising:
requesting that said diagnostic equipment be allocated to said patient;
dispensing said diagnostic equipment to said patient and providing instructions on how to set up said equipment;
setting up said diagnostic equipment in said patient's home in accordance with said instructions; and
returning said diagnostic equipment after use as prescribed by said medical practitioner.

29. A method for providing medical diagnostic equipment to a patient to permit remote assessment by a medical practitioner, said method comprising:
identifying a need for a particular diagnostic equipment to be set up;
requesting that said diagnostic equipment be allocated to said patient;
establishing a link between said diagnostic equipment and an analysis protocol;
using said diagnostic equipment for recording diagnostic data allowing said remote assessment of said patient; and
using said link to select an analysis protocol for analyzing said diagnostic data for said patient before providing said remote assessment.
